(19) United States
(12) Patent Application Publication
(10) Pub. No.: US 2009/0060614 A1
(43) Pub. Date: Mar. 5, 2009

(54) Sheet discharge control system and image forming apparatus including same

(75) Inventor: Ryosuke Hirokawa, Yamato-shi (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/230,297

(22) Filed: Aug. 27, 2008

(30) Foreign Application Priority Data
Aug. 31, 2007 (JP) 2007-226845

(51) Int. Cl. G03G 15/00

(52) U.S. Cl. 399/397

(57) ABSTRACT

A sheet discharge control system used in an image forming apparatus including an image forming unit to form a toner image on a transfer sheet includes a fixer configured to fix the toner image on the transfer sheet by passing the transfer sheet therethrough, a discharge roller located downstream of the fixer in a sheet transport direction, configured to discharge the transfer sheet onto a discharge unit, a transport unit configured to transport the transfer sheet along a transport path between the image forming unit and the discharge unit, a control unit configured to change a sheet transport speed according to one of a number in order of transport or a current position of the transfer sheet.

### CROSS-REFERENCE TO RELATED APPLICATIONS

This patent specification claims priority to Japanese Patent Application No. 2007-226845 filed on Aug. 31, 2007 in the Japan Patent Office, the entire contents of which are hereby incorporated by reference herein.

### BACKGROUND OF THE INVENTION

1. Field of the Invention

The present invention generally relates to a sheet discharge control system used in an electronographic image forming apparatus such as a copier, a printer, a facsimile machine, and a multifunction machine including at least two of these functions.

2. Discussion of the Background Art

Electrographic image apparatuses, such as copiers, printers, facsimile machines, and multifunction machines including at least two of these functions, typically form an electrostatic latent image on a photoreceptor and develop the electrostatic latent image with toner. The developed image is then electrostatically transferred from the photoreceptor onto a recording medium such as a transfer sheet, typically but not always paper, and fixed thereon.

After the image is thus recorded thereon, the sheet is discharged onto a discharge tray or transported to a finisher, attached to the image forming apparatus, that performs post-processing, for example, aligning, sorting, stapling, and/or punching of sheets.

In such image forming apparatuses, a need has arisen to increase productivity, which can be defined as the number of sheets on which images are recorded in a unit time period. One way in which productivity can be increased is by reducing a first-print time, which can be reduced by increasing a linear speed of the image forming apparatus.

However, productivity is increased to only a limited extent by improving the linear speed because strict conditions are required in transport, image transfer, and image fixing to achieve a higher linear speed. Further, when sheets are discharged at a relatively high speed, sheets cannot be neatly aligned on a discharge tray.

To solve these problems, in a known method, a speed with which the sheet is transported, which is hereinafter referred to as a sheet transport speed, is reduced during a punching process, and increased after punching is completed.

In another known method, a speed with which the sheet is discharged is changed so as to smoothly reverse, align, and sort the sheets.

Yet in another method, the sheet transport speed is changed during double-side (duplex) printing so as to increase productivity. Further, in another method, the speed with which the sheet is discharged is changed so as to prevent curvature of sheets and error while the sheets are discharged.

However, it is preferable to improve both productivity as well as alignment of the sheets stacked on the discharge tray simultaneously, which the known methods fail to do.

### SUMMARY OF THE INVENTION

In view of the foregoing, in an illustrative embodiment of the present invention, a sheet discharge control system is used in an image forming apparatus including an image forming unit to form a toner image on a transfer sheet. The sheet discharge control system includes a fixer configured to fix the toner image on the transfer sheet by passing the transfer sheet therethrough, a discharge roller located downstream of the fixer in a sheet transport direction and configured to discharge the transfer sheet onto a discharge unit, a transport unit configured to transport the transfer sheet along a transport path between the image forming unit and the discharge unit, a control unit configured to change a sheet transport speed according to either a number in order of transport or a current position of the transfer sheet.

In another illustrative embodiment, an image forming apparatus includes an image carrier on which a toner image is formed, a transfer unit configured to transfer the toner image from the image carrier onto a transfer sheet, a registration roller located upstream of the transfer unit in the sheet transport direction and configured to transport the transfer sheet to the transfer unit, and the sheet discharge control system described above.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates a schematic configuration of an image forming apparatus according to an illustrative embodiment of the present invention;

FIG. 2 is a block diagram illustrating a configuration of a control unit of the image forming apparatus shown in FIG. 1;

FIG. 3 illustrates a main part of a sheet discharge control system of the image forming apparatus according to an illustrative embodiment of the present invention;

FIG. 4 illustrates a sheet discharge control system according to an illustrative embodiment of the present invention;

FIG. 5 illustrates a sequence of operations performed by the sheet discharge control system shown in FIG. 4;

FIG. 6 illustrates a sheet discharge control system according to another illustrative embodiment of the present invention;

FIG. 7 illustrates a sequence of operations performed by the sheet discharge control system shown in FIG. 6;

FIG. 8 illustrates a sheet discharge control system according to another illustrative embodiment of the present invention;

FIG. 9 illustrates a sequence of operations performed by the sheet discharge control system shown in FIG. 8;

FIG. 10 illustrates a sheet discharge control system according to another illustrative embodiment of the present invention;

FIG. 11 illustrates a sequence of operations performed by the sheet discharge control system shown in FIG. 10;

FIG. 12 illustrates a sheet discharge control system according to another illustrative embodiment of the present invention;

FIG. 13 illustrates a sequence of operations performed by the sheet discharge control system shown in FIG. 12;

FIG. 14 illustrates a sheet discharge control system according to another illustrative embodiment of the present invention; and

FIG. 15 illustrates a sequence of operations performed by the sheet discharge control system shown in FIG. 14.

### DETAILED DESCRIPTION OF PREFERRED EMBODIMENTS

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

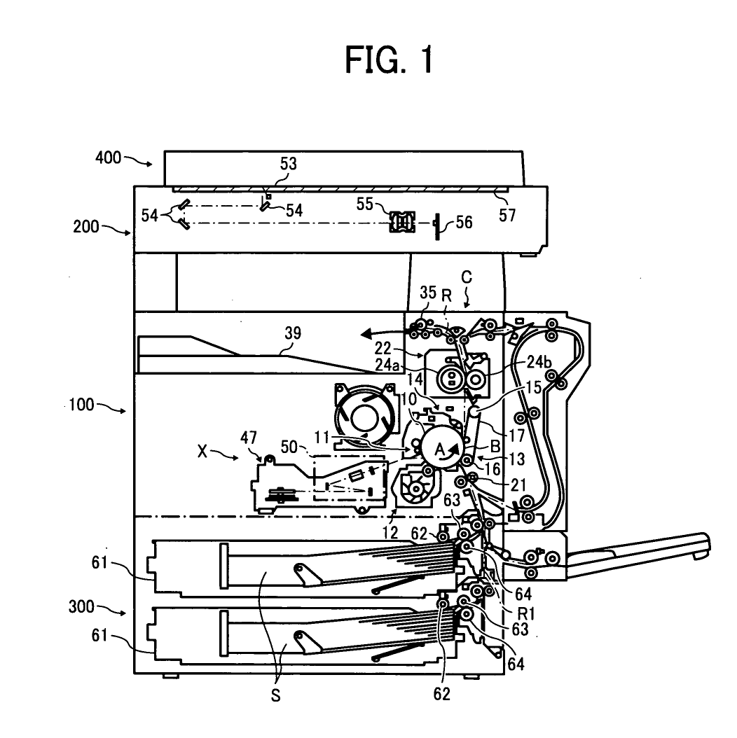

Referring now to the drawings, wherein like reference numerals designate identical or corresponding parts throughout the several views thereof, and particularly to FIG. 1, an electronographic image forming system according to an example embodiment of the present invention is described.

FIG. 1 illustrates a schematic configuration of the image forming system. The image forming system includes an image forming apparatus 100, an image reading unit 200 provided on the image forming apparatus 100, a sheet bank 300 that serves as a sheet feed unit and includes multiple sheet cassettes 61, on which the image forming apparatus 100 is provided, and an automatic document feeder (ADF) 400 provided above the image reading unit 200.

The image forming apparatus 100 includes a drum-shaped photoreceptor 10 serving as an image carrier. A charger 11 is located on the left of the photoreceptor 10 in FIG. 1, and further a developing unit 12, a transfer unit 13, and a cleaner 14 are arranged around the photoreceptor 10 counterclockwise that is a direction indicated by arrow A, in which the photoreceptor 10 rotates. The transfer unit 13 includes rollers 15 and 16, and a transfer belt 17 looped around the rollers 15 and 16. The transfer belt 17 presses against a circumferential surface of the photoreceptor 10.

The image forming apparatus 100 further includes a sheet transport unit C that transports a sheet S of recording media, such as transfer sheets and overhead projector (OHP) films, from one of the sheet cassette 61 to a sheet stack unit 39, located in an upper portion of the image forming apparatus 100, via a transfer position B. The sheet transport unit C includes a sheet feed path R1 and a sheet transport path R. In FIG. 1, the sheet transport path R extends upward, passing the photoreceptor 10 and the transfer unit 13, and then curves to the left.

Along the sheet transport path R, a pair of registration rollers 21 is located upstream of the photoreceptor 10 in a direction in which the sheet S is transported, which is hereinafter referred to as the sheet transport direction. A fixer 22 is located downstream of the photoreceptor 10 in the sheet transport direction and includes a fixing roller 24a inside which a heater is provide and another fixing roller 24b around which a pressure spring and a pressure arm, not shown, are provided. Although not shown in FIG. 1, the image forming apparatus 100 further includes a thermistor and a thermostat, and a temperature of the fixing roller 24a is controlled by turning on and off the heater with the thermostat while detecting the temperature with the thermistor.

The image forming apparatus 100 further includes a pair of discharge rollers 35, located downstream of the fixer 22 in the sheet transport direction, that discharges sheets S on which images are formed onto the sheet stack unit 39, and a laser writing unit 47 located on the left of the developing unit 12 in FIG. 1.

The image reading unit 200 includes a light source 53, multiple mirrors 54, an optical imaging lens 55, an image sensor 56 such as a charge-coupled device (CCD), and a contact glass 57 provided on its upper surface.

The ADF 400 is provided over the contact glass 57 and includes a document table on which an original document to be scanned is placed, a discharge table onto which the scanned original document is discharged, and a document transport unit, not shown. The document transport unit includes multiple transport rollers, serving as sheet transport rotary members, and transports the original document through a transport path from the document table to the discharge table via a reading position on the contact glass 57.

In the sheet bank 300, each sheet cassette 61 is provided with a feeding roller 62, a transport roller 63, and a separation roller 64. The sheet feed path R1 is located on the right of the sheet cassettes 61 in FIG. 1 and connects to the sheet transport path R. Multiple rollers, not shown, provided along the sheet feed path R1 feed the sheets S from the sheet cassettes 61 to the sheet transport path R.

It is to be noted that the photoreceptor 10, the charger 11, the developing unit 12, the transfer unit 13, the cleaner 14, and the registration rollers 21 constitute an image forming unit X.

Operations to make copies using the image forming system shown in FIG. 1 are described below.

First, a user turns the image forming system on and sets an original document on the ADF 300. Alternatively, the user may lift the ADF 400, place the original documents on the contact glass 57 of the image reading unit 200, and hold the original with the ADF 400.

When the user presses a start button, not shown, the document transport unit of the ADF 400 forwards the original document set on the document table onto the contact glass 57. Then, the image reading unit 200 is driven to read image information of the original document placed on the contact glass 57. After the image reading unit 200 reads image information thereof, the original document is discharged onto the discharge table of the ADF 400.

The image reading unit 200 reflects a light from the light source on the original document placed on the contact glass 57 while moving the light source 53 along the contact glass 57, and further reflects the light on the multiple mirrors 54 to the imaging lens 55. The light is then directed to the image sensor 56 that reads the image information.

Along with the operations described above, in the image forming apparatus 100, the charger 11 uniformly * charges the surface of the photoreceptor 10, and then the laser writing unit 47 applies a laser light according to the image information read by the image reading unit 200 thereonto while the photoreceptor 10 is rotates by a motor, not shown, forming an electrostatic latent image thereon. The developing unit 12 develops the electrostatic latent image with toner into a toner image.

Pressing the start button further causes the sheet bank 300 to feed the sheets S to the image forming apparatus 100. More specifically, one of the sheet cassettes 61 is selected and the feed roller 62 corresponding to that sheet cassette 61 draws out the sheets S contained therein. Then, the transport roller 63 and the separation roller 64 feed the sheets S one by one to the sheet feed path R1.

The sheet S is further transported through the sheet feed path R1 by the transport rollers, not shown, to the sheet transport path R. Then, the registration rollers 21 stop the sheet S by sandwiching its leading edge portion therebetween. The registration rollers 21 rotate to send the sheet S to the right of the photoreceptor 10 in synchronization with movement of the toner image formed on the rotating photoreceptor 10.

Then, the transfer unit 13 transfers the toner image from the photoreceptor 10 onto the sheet S at the transfer position B. After the toner image is thus transferred from the photoreceptor 10, the cleaner 14 removes any toner remaining thereon, and then a discharger, not shown, removes electricity remaining thereon as preparation for subsequent image formation.

The sheet S bearing the image is transported by the transfer belt 17, and then the fixer 22 fixes the image thereon with heat and pressure while the sheet S passes between the roller 24a and 24b. After the image is fixed, the discharge rollers 35 discharge the sheet S onto the sheet stack unit 39.

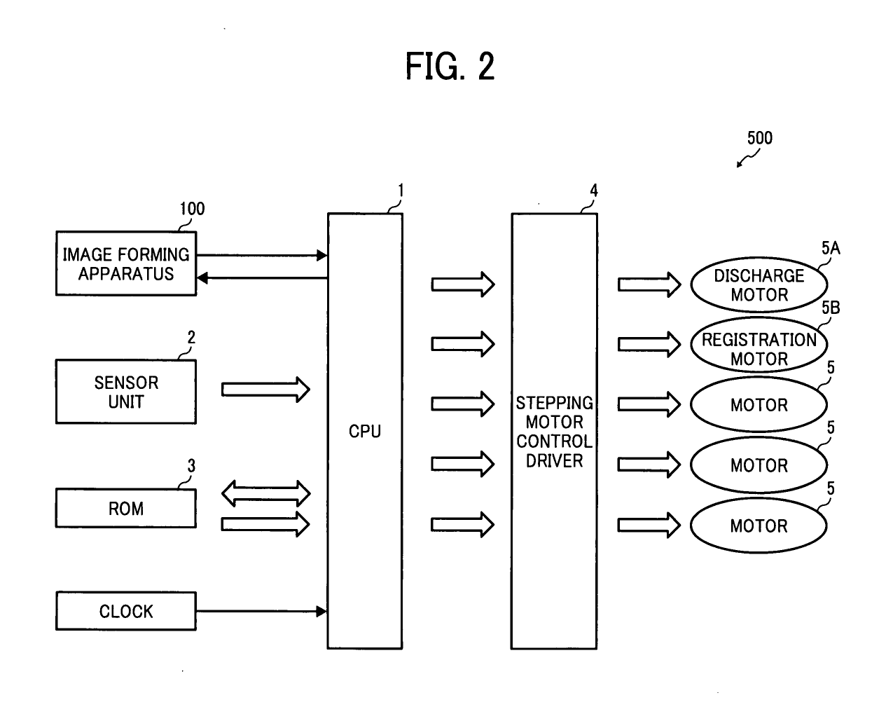

FIG. 2 illustrates an example of a configuration of a control unit 500 that controls the image forming system shown in FIG. 1. The control unit 500 includes a central processing unit (CPU) 1, a sensor unit 2, a read-only memory (ROM) 3, a stepping motor control driver 4, a discharge motor 5A, a registration motor 5B, motors 5, and a random access memory (RAM), not shown. The CPU 1 exchanges signals with the image forming apparatus 100 and outputs control signals in order to control respective parts of the image forming system based on detection signals and clocks sent from respective sensors.

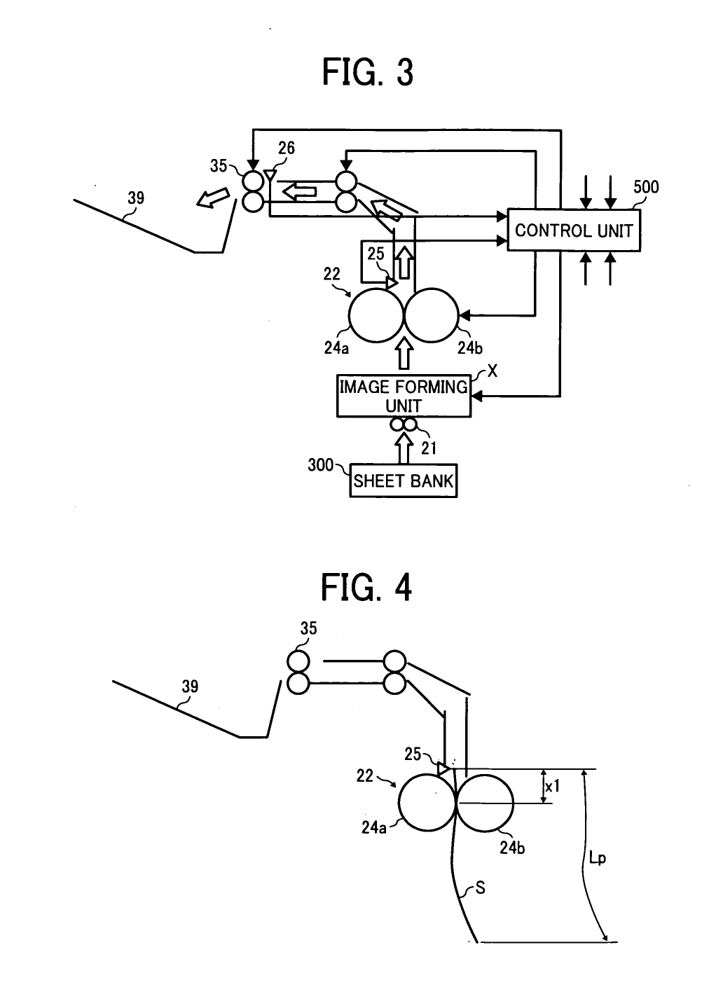

FIG. 3 illustrates a main part of the image forming system shown in FIG. 1, provided with a sheet discharge control system. Referring to FIGS. 1 through 3, sheet discharge control according to an illustrative embodiment of the present invention is described below.

As described above, the sheet S transported from the sheet bank 300 (sheet feed unit) is stopped by the registration rollers 21 located upstream of the image forming unit X in the sheet transport direction. As described above, the image forming unit X includes the photoreceptor 10, the charger 11, the developing unit 12, the transfer unit 13, and the cleaner 14 shown in FIG. 1.

Then, the registration rollers 21 timely transport the sheet S so that the sheet S reaches the transfer direction B when the toner image on the photoreceptor 10 reaches a position facing the transfer unit 13. After the transfer unit 13 transfers the image from the photoreceptor 10 onto the sheet S in the image forming unit X, the fixer 22 fixes the image thereon while the sheet S passes therethrough, and then the discharge rollers 35 discharge the sheet S onto the sheet stack unit 39.

A first sheet detector 25 is provided downstream of the fixer 22 or a fixing nip, and a second sheet detector 26 is provide upstream of the discharge rollers 35. Costs of the first sheet detector 25 and the second sheet detector 26 can be lower when a filler type transmission sensor is used. By contrast, when a reflection sensor is used, detection accuracy can be higher. The first sheet detector 25 and the second detector 26 are activated when the sheet S is present at positions facing the first sheet detector 25 and the second sheet detector 26, respectively.

It is to be noted that the discharge rollers 35 and other rollers to transport the sheet S along the sheet transport path R from the fixer 22 to the sheet stack unit 39, and a driving source thereof constitute what is hereinafter referred to as a transport unit or a discharge mechanism, with the portion of the sheet transport path R between the fixer 22 and the sheet stack unit 39 also referred to as a discharge path. The driving source of the discharge mechanism is the discharge motor 5A.

In the sheet discharge control system according to the present embodiment, the control unit 500 changes a speed with which the transport unit transports the sheet S, which is hereinafter referred to as the sheet transport speed or discharge speed, depending on a number in order of transport in continuous image formation in which the image forming unit X continuously forms images on multiple sheets, sheet type, and a current position of the sheet S.

For example, when a sheet whose number in order of transport is first in continuous image formation, which is hereinafter simply referred to as a first sheet, is discharged, the sheet transport speed can be selected from among multiple speeds including a standard speed. Alternatively, the control unit 500 can control the transport unit to transport individual sheets at different speeds, such as the standard speed, a lower speed, or a higher speed, according to the current position thereof.

Thus, the sheet discharge speed can be changed as required or preferred. For example, the first-print time can be reduced by increasing the discharge speed. Alternatively, by reducing the discharge speed, noise can be reduced, alignment of the sheets S stacked on the sheet stack unit 39 can be improved, and temperature increases can be restricted.

For example, when the image forming unit X forms images on multiple sheets S, the sheet transport speed is changed regarding only the first sheet. By increasing the sheet transport speed when a trailing edge portion of the first sheet leaves the roller 24a and the roller 24b and reducing the sheet transport speed to the standard speed or lower speed when the second sheet detector 26 detects the first sheet, the first-print time can be reduced and at the same time noise and temperature increases restricted and sheet alignment improved.

A description is now given of a configuration and operation of the sheet discharge control system. It is to be noted that, for simplicity, the control unit 500 is omitted in FIGS. 4, 6, 8, 10, 12, and 14.

FIG. 4 illustrates a configuration and operation of the sheet discharge control system according to an illustrative embodiment of the present invention. The configuration shown in FIG. 4 is similar to that shown in FIG. 3 except that a second sheet detector 26 is not included, and thus descriptions thereof are omitted. FIG. 4 illustrates a state in which the leading edge portion of the sheet S reaches the first sheet detector 25.

In the present embodiment, the transport unit is controlled to increase the sheet transport speed immediately after its trailing edge portion leaves the fixer 22 (fixing nip) and then discharge the sheet S onto the sheet stack unit 39, thus enabling the first-print time to be reduced.

Because strict fixing conditions are required in order to increase the sheet transport speed while the sheet S is inside the fixer 22, the sheet transport speed is preferably increased only after the trailing edge portion of the sheet S has already passed through the fixer 22. A time period T1 from when the leading edge portion of the sheet S reaches the first sheet detector 25 until when its trailing edge portion reaches the fixer 22 is expressed by

T1=(Lp−x1)/Vp

wherein Lp represents a length of the sheet S, Vp represents the standard transport speed of the sheet S (linear speed), and x1 represents a distance between the fixer 22 and the first sheet detector 25.

A time point at which the sheet S leaves the fixer 22 can be determined based on the time period T1. Hereinafter the reference character T1 also refers to a time point when the time period T1 has elapsed after the sheet S reaches the first sheet detector 25. In the present embodiment, the sheet transport speed can be increased any time after the time point T1.

When the sheet transport speed of the first sheet is increased at the time point T1, the first-print time can be reduced without affecting the fixing conditions.

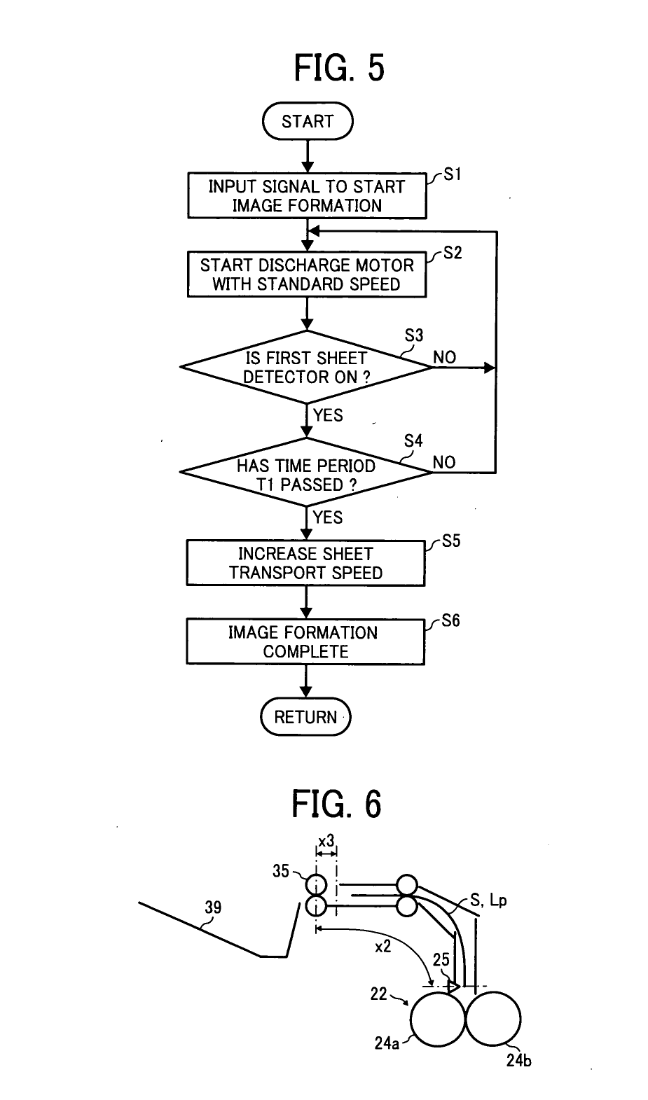

FIG. 5 illustrates a sequence of the operations performed by the sheet discharge control system shown in FIG. 4.

As shown in FIG. 5, at S1 when the user inputs a signal to start image formation, for example, by pressing the start button, at S2 the discharge motor 5A shown in FIG. 2 starts to drive the discharge mechanism at the standard transport speed Vp. When the control unit 500 determines At S3 that the first sheet detector 25 is on, at S4 the control unit 500 determines whether or not the time period T1 has elapsed after the first sheet detector 25 turns on. When the time period T1 has elapsed (YES at S4), at S5 the discharge motor 5A shown in FIG. 2 is set so that the sheet transport speed is increased from the standard speed Vp to a higher speed (increased transport speed) Va. At S6, when image formation is completed, the sequence returns to the first step in the process.

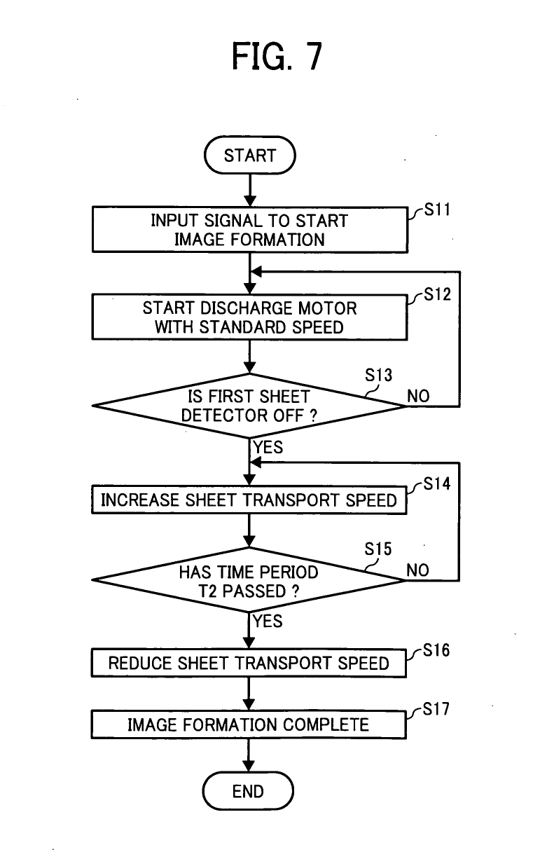

A sheet discharge control system according to another embodiment is described below with reference to FIGS. 6 and 7. The sheet discharge control system shown in FIG. 6 has a configuration similar to that shown in FIG. 4 and does not include a second sheet detector 26, and thus descriptions thereof are omitted.

FIG. 6 illustrates a state in which the trailing edge portion of the sheet S reaches the first sheet detector 25. Because strict fixing conditions are required in order to increase the sheet transport speed while the sheet S is inside the fixer 22, the sheet transport speed is preferably increased only after the trailing edge portion of the sheet S has already passed through the fixer 22.

Because arrival of the trailing edge portion of the sheet S at the first sheet detector 25 means that the sheet S has elapsed through the fixer 22, the time point at which the standard transport speed Vp is increased can be set to the time point when the trailing edge portion of the sheet S reaches the first sheet detector 25, or any time after that time point.

Further, by starting timing when the trailing edge portion of the sheet S reaches the first sheet detector 25, the time point at which the sheet transport speed is reduced can be determined without a second sheet detector 26, reducing the cost.

A time period from when the trailing edge portion of the sheet S reaches the first sheet detector 25 until when the sheet transport speed is reduced, which is hereinafter referred to as a time period T2, can be calculated by

T2=(x2−x3)/Va

wherein x2 represents a distance from the first sheet detector 25 to a nip formed between the discharge rollers 35, which is hereinafter referred to as the discharge roller nip, x3 represents a distance between the discharge roller nip and the location of the trailing edge portion of the sheet S when the sheet transport speed is reduced, and Va represents the increased transport speed (linear speed).

According to the formula described above, by reducing the sheet transport speed after the time period T2 has elapsed from when the trailing edge portion of the sheet S reaches the first sheet detector 25, the sheet transport speed can be reduced when the trailing edge portion of the sheet S is at the distance x3 upstream of the discharge roller nip. Thus, the sheets S are not thrown out onto the sheet stack unit 39 and can be better aligned thereon.

As described above, in the present embodiment, the sheet transport speed is increased after the first sheet detector 25 detects the trailing edge portion of the sheet S and reduced after a predetermined or desirable time period has elapsed therefrom before the discharge rollers 35 discharge the sheet S onto the sheet stack unit 39.

FIG. 7 illustrates a sequence of the operations performed by the sheet discharge control system shown in FIG. 6.

As shown in FIG. 7, when the user inputs a signal to start image formation at S11, for example by pressing the start button, at S12 the discharge motor 5A starts to drive the discharge mechanism with the standard transport speed Vp. When the first sheet detector 25 turns off at S13, after the trailing edge portion of the sheet S passes the first sheet detector 25, at S14 the discharge motor 5A is set so that the sheet transport speed is increased to the increased speed Va.

At S15, the control unit 500 determines whether or not the time period T2 has elapsed after the trailing edge portion of the sheet S reaches the first sheet detector 25. When the time period T2 has elapsed (YES at S15), at S16 the sheet transport speed is reduced to the standard transport speed Vp or a speed lower than that. At S17, when image formation is completed, the sequence returns to the first step.

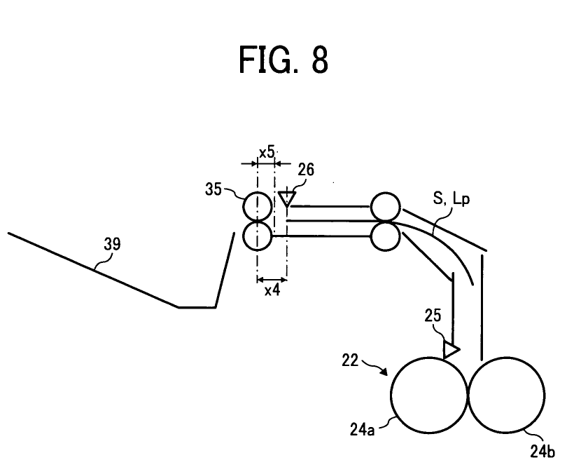

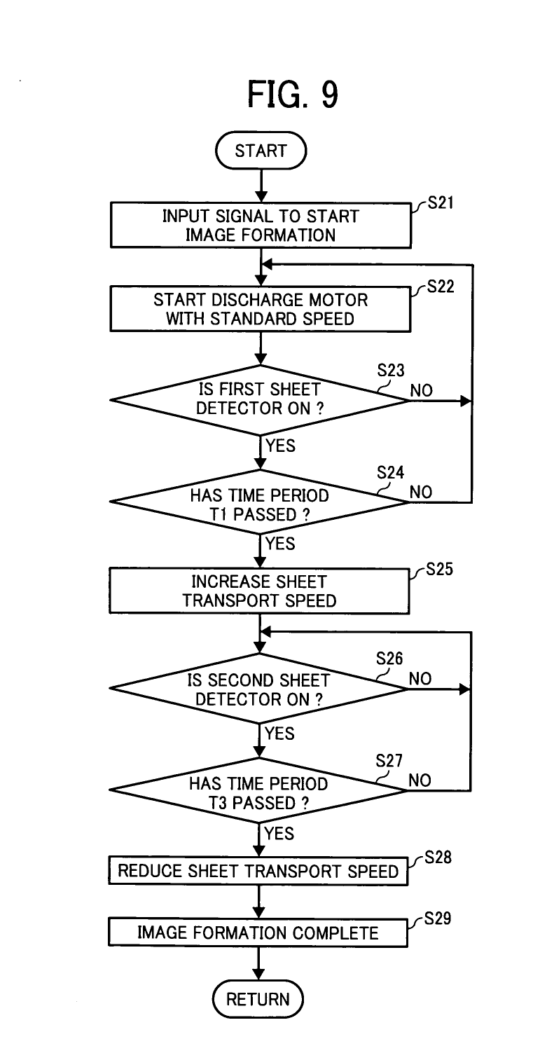

A sheet discharge control system according to another embodiment is described below with reference to FIGS. 8 and 9. The sheet discharge control system shown in FIG. 8 has a configuration similar to that shown in FIG. 3 and includes both a first sheet detector 25 and a second sheet detector 26, with descriptions of other parts omitted.

FIG. 8 illustrates a state in which the leading edge portion of the sheet S reaches the second sheet detector 26. By starting timing when the leading edge portion of the sheet S reaches the second sheet detector 26, the time point at which the sheet transport speed is to be reduced can be determined in order to reduce the sheet transport speed before the sheet S leaves the discharge roller nip.

A time period from when the leading edge portion of the sheet S reaches the second sheet detector 26 until when the sheet transport speed is reduced, which is hereinafter referred to as a time period T3, can be calculated by

T3=(Lp+x4−x5)/Va

wherein Lp represents the length of the sheet S, x4 represents a distance between the second sheet detector 26 and the discharge roller nip, x5 represents a distance between the discharge roller nip and the position of the trailing edge portion of the sheet S when the sheet transport speed is reduced, and Va represents the increased transport speed.

According to the formula described above, by reducing the sheet transport speed after the time period T3 has elapsed from when the leading edge portion of the sheet S reaches the second sheet detector 26, the sheet transport speed can be reduced when the trailing edge portion of the sheet S is at the distance x5 upstream of the discharge roller nip. Thus, the sheets S are not thrown out onto the sheet stack unit 39 and can be better aligned thereon.

As described above, in the present embodiment, the sheet transport speed is increased after the first sheet detector 25 detects the trailing edge portion of the sheet S and reduced after a predetermined or desirable time period has elapsed after the second sheet detector 26 detects the leading edge portion of the sheet S.

It is to be noted that, when the second sheet detector 26 and the discharge rollers 35 are in comparatively close proximity to each other, and the control unit 500 reduces the sheet transport speed when the trailing edge portion of the sheet S reaches the second sheet detector 26, the trailing edge portion of the sheet S might reach the discharge rollers 35 before the sheet transport speed is reduced, depending on slew-down characteristic of the discharge motor 5A shown in FIG. 2.

Therefore, in the present embodiment, in order to make certain that the sheet transport speed is reduced before the discharge rollers 35 discharge the sheet S, timing is started when the second sheet detector 26 detects the leading edge portion of the sheet S and the sheet transport speed is reduced when the time period T3 has elapsed therefrom. Thus, even when the second sheet detector 26 and the discharge rollers 35 are close together, the sheet transport speed can be reduced before the sheet S is disengaged from the discharge rollers 35.

FIG. 9 illustrates a sequence of the operations performed by the sheet discharge control system shown in FIG. 8.

As shown in FIG. 9, at S21 when a signal to start image formation is input, at S22 the discharge motor 5A starts to drive the discharge mechanism with the standard transport speed Vp. At S23, when the control unit 500 determines that the first sheet detector 25 is on, that is, the sheet S is present at the first sheet detector 25 (YES at S23), at S24 the control unit 500 determines whether or not the time period T1 has elapsed after the first sheet detector 25 turns on.

When the time period T1 has elapsed (YES at S24), at S25 the discharge motor 5A is set so that the sheet transport speed is increased to the higher speed (increased transport speed) Va. At S26, the control unit 500 checks whether or not the second sheet detector 26 is on. When the second sheet detector 26 is on (YES at S26), at S27 the control unit 500 determines whether or not the time period T3 has elapsed after the second sheet detector 26 turns on.

When the time period T3 has elapsed after the second sheet detector 26 turns on (YES at S27), at S28 the sheet transport speed is reduced to the standard transport speed Vp or a speed lower than that. Then, when image formation is completed, the sequence returns to the first step.

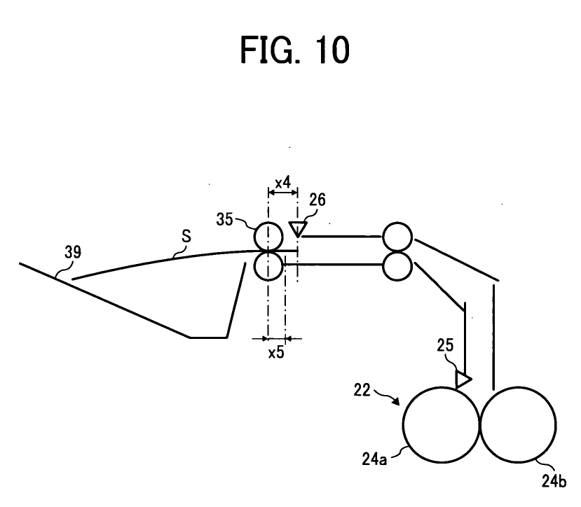

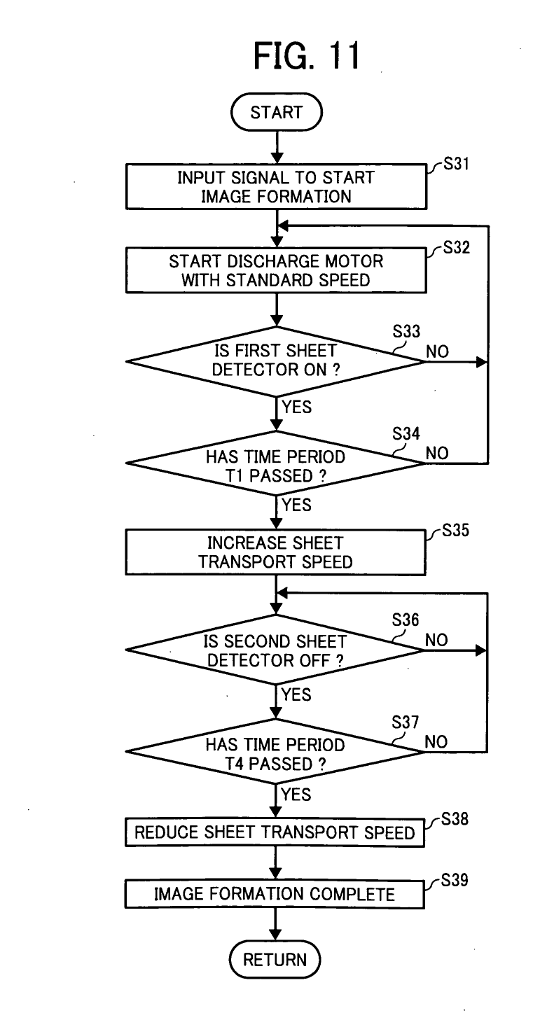

A discharge control system according to another embodiment is described below with reference to FIGS. 10 and 11. The sheet discharge control system shown in FIG. 10 has a configuration similar to that shown in FIG. 3 and includes both a first sheet detector 25 and a second sheet detector 26, with descriptions of other parts omitted.

FIG. 10 illustrates a state in which the trailing edge portion of the sheet S reaches the second sheet detector 26. By reducing the sheet transport speed when the trailing edge portion of the sheet S reaches the second sheet detector 26 or a predetermined or given time period has elapsed therefrom, the sheet transport speed can be reduced before the sheet S is disengaged from the discharge rollers 35.

The time period from when the trailing edge portion of the sheet S reaches the second sheet detector 26 and until when a trailing edge thereof reaches the discharge rollers 35 is hereinafter referred to as a time period T4.

The time period T4 can be calculated by

T4=(x4−x5)/Va

wherein Va represents the increased transport speed, x4 represents the distance between the second sheet detector 26 and the discharge roller nip, and x5 represents the distance between the discharge roller nip and an upstream end of the discharge rollers 35 in the sheet transport direction.

That is, the sheet transport speed is reduced when or before the trailing edge of the sheet S reaches the upstream end of the discharge rollers 35.

By reducing the sheet transport speed within the time period T4 after the trailing edge portion of the sheet S reaches the second sheet detector 26, the sheet transport speed can be reduced before the sheet S is disengaged from the discharge rollers 35. Thus, the sheets S are not thrown out onto the sheet stack unit 39 and can be better aligned thereon.

FIG. 11 illustrates a sequence of the operations performed by the sheet discharge control system shown in FIG. 10.

Referring to FIG. 11, at S31 through S35, operations similar to those performed at S21 through 25 shown in FIG. 9 are performed. At S36, the control unit 500 checks whether or not the second sheet detector 26 turns off, that is, the trailing edge portion of the sheet S has elapsed the second sheet detector 26. When the second sheet detector 26 turns off (YES at S36), at S37 the control unit 500 determines whether or not the time period T4 has elapsed after the second sheet detector 26 turns off.

When the time period T4 has elapsed after the second sheet detector 26 turns off (YES at S37), at S38 the sheet transport speed is reduced to the standard transport speed Vp or a speed lower than that. Then, when image formation is completed, the sequence returns to the first step.

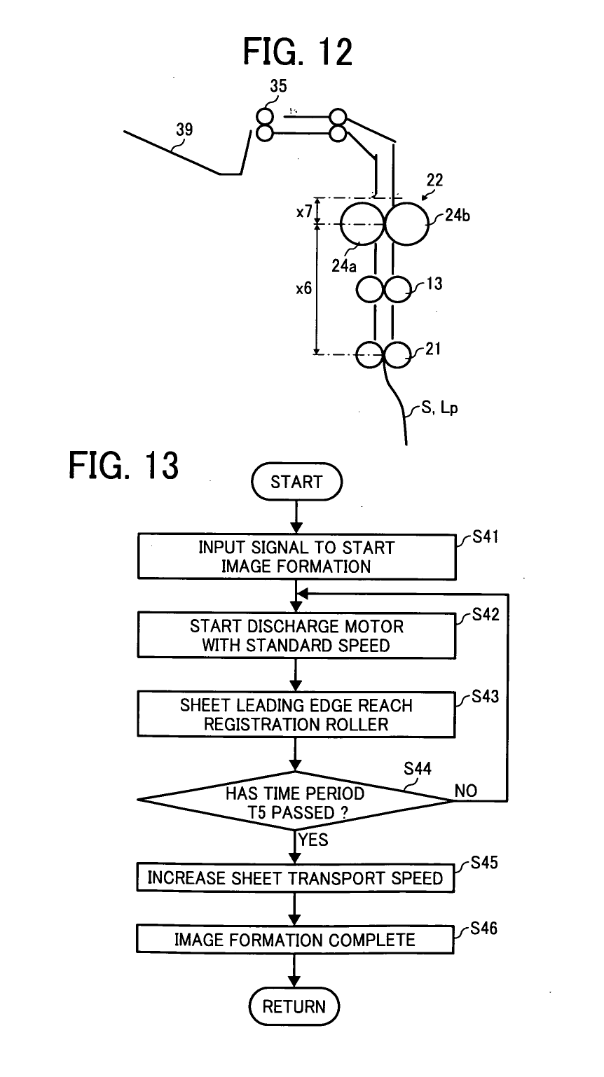

A discharge control system according to another embodiment is described below with reference to FIGS. 12 and 13. The sheet discharge control system shown in FIG. 12 includes neither a first sheet detector 25 nor a second sheet detector 26. Other than that, the sheet discharge control system shown in FIG. 12 has a configuration similar to that shown in FIG. 3, and thus a description thereof is omitted.

FIG. 12 illustrates a state in which the leading edge portion of the sheet S reaches the registration rollers 21 located upstream of the transfer unit 13 in the sheet transport direction. Because strict fixing conditions are required in order to increase the sheet transport speed while the sheet S is within the fixer 22, the sheet transport speed is preferably increased only after the trailing edge portion of the sheet S has already elapsed through the fixer 22.

Therefore, in the present embodiment, timing is started when the leading edge portion of the sheet S has elapsed the registration rollers 21, and the sheet transport speed is increased after the trailing edge portion thereof leaves the fixer 22 or reaches a given point downstream of the fixer 22.

A time period from when the leading edge portion of the sheet S has elapsed the registration rollers 21 until when the trailing edge portion thereof leaves the fixer 22 or reaches the given point downstream thereof, which is hereinafter referred to as a time period T5, can be calculated by

T5=(Lp+x6−x7)/Vp

wherein Lp represents the length of the sheet S, x6 represents a distance between the registration rollers 21 and the fixing nip (fixer 22), and x7 represents a distance between the fixing nip and a given position downstream of the fixer 22, where the trailing edge portion of the sheet S is located when the sheet transport speed is increased.

By increasing the sheet transport speed when the time period T5 has elapsed after the leading edge portion of the sheet S reaches the registration rollers 21, the first-print time can be reduced without affecting the fixing conditions.

FIG. 13 illustrates a sequence of the operations performed by the sheet discharge control system shown in FIG. 12.

As shown in FIG. 13, at S41 when a signal to start image formation is input, at S42 the discharge motor 5A starts to drive the discharge mechanism with the standard transport speed Vp. At S43, when the control unit 500 determines that the leading edge portion of the sheet S reaches the registration rollers 21, the control unit 500 starts timing.

Then, at S44 the control unit 500 determines whether or not the time period T5 has elapsed after the leading edge portion of the sheet S reaches the registration rollers 21. When the time period T5 has elapsed (YES at S 44), at S45 the discharge motor 5A is set so that the sheet transport speed is increased to the higher speed (increased transport speed) Va. At S46, when image formation is completed, the sequence returns to the first step.

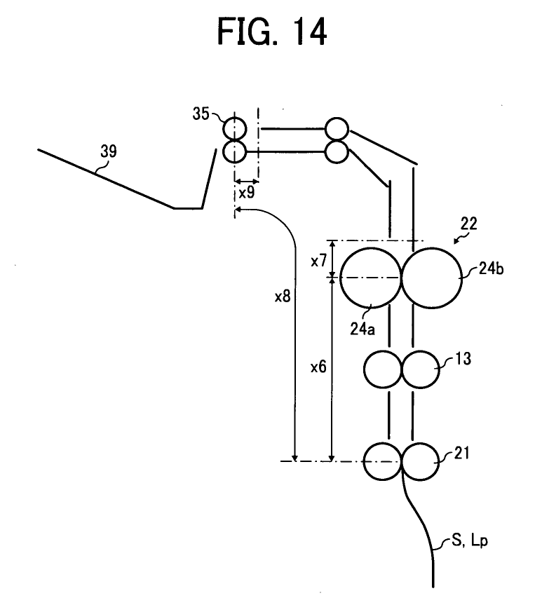

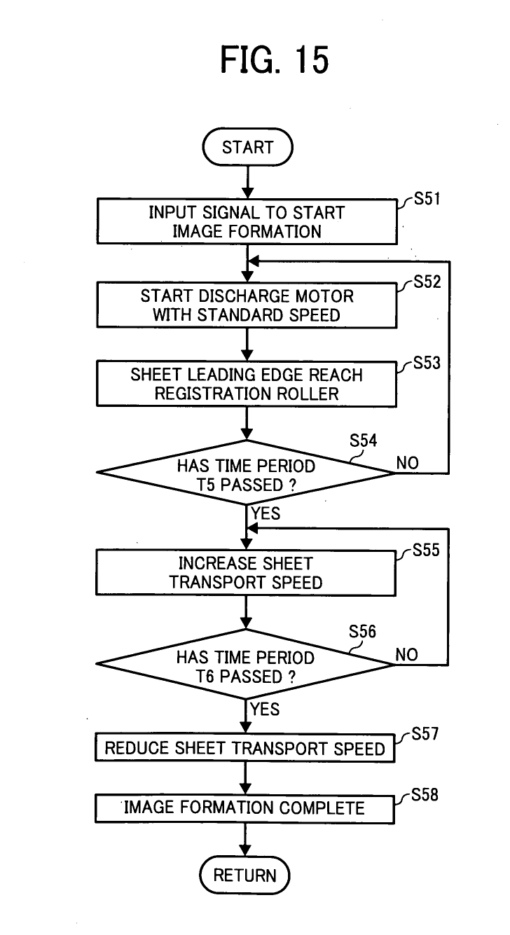

A discharge control system according to another embodiment is described below with reference to FIGS. 14 and 15, which has a configuration similar to that shown in FIG. 12 and does not include either a first sheet detector 25 or a second sheet detector 26.

FIG. 14 illustrates a state in which the leading edge portion of the,sheet S reaches the registration rollers 21.

In the present embodiment, the sheet transfer speed is increased after the trailing edge portion of the sheet S passes the fixer 22, for example, according to the method described above with reference to FIGS. 12 and 14.

Further, the sheet transport speed is reduced when a given time period T6 has elapsed after the leading edge portion of the sheet S reaches the registration rollers 21 in order to reduce the sheet transport speed before the sheet S is disengaged from the discharge rollers 35.

The time period T6 from when the leading edge portion of the sheet S reaches the registration rollers 21 until when the trailing edge portion thereof reaches a given point upstream of the discharge roller unit, that is when the sheet transport speed is reduced, can be calculated by

T6=(x8+Lp−x6−x7−x9)/Va+(Lp+x6+x7)/Vp

wherein Lp represents the length of the sheet S, Vp represents the standard transport speed, Va represents the increased transport speed, x6 represents the distance between the registration rollers 21 and the fixing nip (fixer 22), x7 represents the distance between the fixing nip and the position of the trailing edge portion of the sheet S when the sheet transport speed is increased, x8 represents a distance between the registration rollers 21 and the discharge roller nip, and x9 represents the distance between the discharge roller nip and the given point upstream of the discharge roller nip, where the trailing edge portion of the sheet S is located when the sheet transport speed is reduced.

By reducing the sheet transport speed when the time period T6 has elapsed after the leading edge portion of the sheet S reaches the registration rollers 21, the sheet transport speed can be reduced before the sheet S is disengaged from the discharge rollers 35. Thus, the sheets S are not thrown out onto the sheet stack unit 39 and can be better aligned thereon.

FIG. 15 illustrates a sequence of the operations performed by the sheet discharge control system shown in FIG. 14.

As shown in FIG. 14, from S51 through 55, operations similar to those performed from S41 through S45 are performed. At S56, the control unit 500 determines whether or not the time period T6 has elapsed after the leading edge portion of the sheet S reaches the registration rollers 21. When the time period T6 has elapsed (YES at S 56), at S57 the discharge motor 5A is set so that the sheet transport speed is reduced to the standard transport speed Vp or a speed lower than that. At S58, when image formation is completed, the sequence returns to the first step.

Numerous additional modifications and variations are possible in light of the above teachings. It is therefore to be understood that, within the scope of the appended claims, the disclosure of this patent specification may be practiced otherwise than as specifically described herein.

What is claimed is:

1. A sheet discharge control system used in an image forming apparatus including an image forming unit to form a toner image on a transfer sheet,
the sheet discharge control system, comprising:
a fixer configured to fix the toner image on the transfer sheet by passing the transfer sheet therethrough;
a discharge roller located downstream of the fixer in a sheet transport direction, configured to discharge the transfer sheet onto a discharge unit;
a transport unit configured to transport the transfer sheet along a transport path between the image forming unit and the discharge unit; and
a control unit configured to change a sheet transport speed according to one of a number in order of transport or a current position of the transfer sheet.

2. The sheet discharge control system according to claim 1, wherein the control unit cause the transport unit to increase the sheet transport speed after a trailing edge portion of the transfer sheet is disengaged from the fixer and discharge the transfer sheet onto the discharge unit.

3. The sheet discharge control system according to claim 1, wherein the control unit causes the transport unit to increase the sheet transport speed of only a first transfer sheet of multiple transfer sheets in a continuous image formation operation, after a trailing edge portion of the first transfer sheet is disengaged from the fixer and discharge the transfer sheet onto the discharge unit.

4. The sheet discharge control system according to claim 1, wherein the control unit causes the transport unit to increase the sheet transport speed after a trailing edge portion of the transfer sheet is disengaged from the fixer, reduce the sheet transport speed before the trailing edge portion of the transfer sheet is disengaged from the discharge roller, and discharge the transfer sheet onto the discharge unit.

5. The sheet discharge control system according to claim 1, wherein the control unit causes the transport unit to increase the sheet transport speed of only a first transfer sheet of multiple transfer sheets in a continuous image formation operation, after a trailing edge portion of the first transfer sheet is disengaged from the fixer, reduce the sheet transport speed before the trailing edge portion of the transfer sheet is disengaged from the discharge roller, and discharge the transfer sheet onto the discharge unit.

6. The sheet discharge control system according to claim 1, wherein the image forming unit comprises:
an image carrier on which a toner image is formed;
a transfer unit configured to transfer the toner image from the image carrier onto the transfer sheet; and
a registration roller located upstream of the transfer unit in the sheet transport direction, configured to transport the transfer sheet to the transfer unit,
wherein the control unit starts timing when the registration roller starts transporting the transfer sheet, and causes the transport unit to increase the sheet transport speed after a predetermined time period has elapsed after the registration roller starts transporting the transfer sheet and discharge the transfer sheet onto the discharge unit.

7. The sheet discharge control system according to claim 1, wherein the image forming unit comprises:
an image carrier on which a toner image is formed;
a transfer unit configured to transfer the toner image from the image carrier onto the transfer sheet; and
a registration roller located upstream of the transfer unit in the sheet transport direction, configured to transport the transfer sheet to the transfer unit,
wherein the control unit starts timing when registration roller starts transporting the transfer sheet, determines a time point at which the sheet transport speed is increased, and causes the transport unit to reduce the sheet transport speed after a predetermined time period has elapsed after the registration roller starts transporting the transfer sheet.

8. The sheet discharge control system according to claim 1, further comprising a sheet detector located downstream of the fixer in the sheet transport direction,
wherein the control unit causes the transport unit to increase the sheet transport speed when a predetermined time period has elapsed after the sheet detector detects a leading edge portion of the transfer sheet and discharge the transfer sheet onto the discharge unit.

9. The sheet discharge control system according to claim 1, further comprising a sheet detector located downstream of the fixer in the sheet transport direction,
wherein the control unit causes the transport unit to increase the sheet transport speed after a predetermined time period passes after the sheet detector detects a trailing edge portion of the transfer sheet and discharge the transfer sheet onto the discharge unit.

10. The sheet discharge control system according to claim 1, further comprising a sheet detector located downstream of the fixer in the sheet transport direction,
wherein the control unit determines a time point at which the sheet transport speed is increased after the sheet detector detects a trailing edge portion of the transfer sheet, and causes the transport unit to reduce the sheet transport speed after a predetermined time period passes after the sheet detector detects the trailing edge portion of the transfer sheet and discharge the transfer sheet onto the discharge unit.

11. The sheet discharge control system according to claim 1, further comprising a sheet detector located upstream of the discharge roller in the sheet transport direction,
wherein the control unit determines a time point at which the sheet transport speed is increased after the sheet detector detects a leading edge portion of the transfer sheet.

12. The sheet discharge control system according to claim 1, further comprising a sheet detector located upstream of the discharge roller in the sheet transport direction,
wherein the control unit causes the transport unit to reduce the sheet transport speed after a predetermined time period passes after the sheet detector detects a leading edge portion of the transfer sheet.

13. The sheet discharge control system according to claim 1, further comprising a sheet detector located upstream of the discharge roller in the sheet transport direction,
wherein the control unit causes the transport unit to reduce the sheet transport speed after the sheet detector detects a trailing edge portion of the transfer sheet.

14. The sheet discharge control system according to claim 8, wherein the sheet detector is a filler type transmission sensor.

15. The sheet discharge control system according to claim 8, wherein the sheet detector is a reflection sensor.

16. The sheet discharge control system according to claim 11, wherein the sheet detector is a filler type transmission sensor.

17. The sheet discharge control system according to claim 11, wherein the sheet detector is a reflection sensor.

18. An image forming apparatus comprising:
an image carrier on which a toner image is formed;
a transfer unit configured to transfer the toner image from the image carrier onto a transfer sheet;
a registration roller located upstream of the transfer unit in a sheet transport direction, configured to transport the transfer sheet to the transfer unit; and
a sheet discharge control system including:
a fixer configured to fix the toner image on the transfer sheet by passing the transfer sheet therethrough,
a discharge roller located downstream of the fixer in the sheet transport direction, configured to discharge the transfer sheet onto a discharge unit,
a transport unit configured to transport the transfer sheet along a transport path between the image forming unit and the discharge unit, and
a control unit configured to change a sheet transport speed according to one of a number in order of transport or a current position of the transfer sheet.
